(19) United States
(12) Patent Application Publication
(10) Pub. No.: US 2013/0276003 A1
(43) Pub. Date: Oct. 17, 2013

(54) OPTICAL DISC UNIT

(71) Applicant: HITACHI-LG DATA STORAGE, INC., Tokyo (JP)

(72) Inventors: Koji MATSUMOTO, Kuala Lumpur (MY); Hideyuki NAGAMINE, Urayasu-shi (JP); Seiji HAMAIE, Kawasaki-shi (JP); Nozomu HARADA, Kawasaki-shi (JP)

(73) Assignee: Hitachi-LG Data Storage, Inc., Tokyo (JP)

(21) Appl. No.: 13/859,823

(22) Filed: Apr. 10, 2013

(30) Foreign Application Priority Data
Apr. 11, 2012 (JP) 2012-090065

(51) Int. Cl. G11B 17/056

(52) U.S. Cl. CPC G11B 17/056
USPC 720/613

(57) ABSTRACT

A disadvantage is reduced in which a front panel of an optical disc unit tilts by a clearance (rattle) between the components and contacts with a body of a PC incorporating the unit to cause malfunction of insertion and ejection of discs. A disc tray is provided to move relative to rail guides attached to a bottom case of the optical disc unit via rails. The disc tray and rail guides have projection portions to contact with each other with stress. As a result, the clearance is reduced and the disadvantage due to the malfunction is reduced. The contact of the projection portions is close to point contact. The number of the contact positions is three or four. Support portions are provided to the rail guides to generate the stress.

### INCORPORATION BY REFERENCE

This application relates to and claims priority from Japanese Patent Application No. 2012-090065 filed on Apr. 11, 2012, the entire disclosure of which is incorporated herein by reference.

### BACKGROUND OF THE INVENTION

(1) Field of the Invention

The present invention relates to an optical disc unit, particularly to an optical disc unit having a disc tray whose tilt relative to a body is reduced.

(2) Description of the Related Art

Optical disc units mounted in, e.g., note type personal computers (hereinafter abbreviated to PCs) are strongly desired to be reduced in size, weight, and thickness. Optical disc units having a thickness of 12.7 mm or 9.5 mm are popular now. Technologies for further thickness reduction are developing.

Japanese Patent Application Laid-Open No. 2009-283110 (hereafter described as Patent Document 1) discloses an optical disc unit having a mechanism to emergently eject an optical disc without increasing a thickness of the unit.

### SUMMARY OF THE INVENTION

In such above optical disc units having a reduced thickness, a clearance between a PC and the unit mounted therein is small in many cases. For this reason, when a disc tray that mounts, inserts, and ejects an optical disc tilts, a front panel of the optical disc unit and a body of the PC around the optical disc insert portion contact with one another, which may cause, e.g., a malfunction of the ejection. Patent Document 1 and others do not disclose solutions to this malfunction particularly.

In view of the above disadvantage, an object of the present invention is to provide an optical disc unit having a disc tray whose tilt relative to a body is reduced.

For addressing the above disadvantage, the present invention provides an optical disc unit that inserts an optical disc therein as a recording medium and ejects the inserted optical disc externally. The optical disc unit includes: a bottom case that externally covers a bottom side of the optical disc unit; a disc tray that carries and inserts the optical disc inside the optical disc unit, and ejects the optical disc therefrom; rails that guide and move the disc tray while changing its relative position; rail guides that guide and move the rails while changing their relative positions and that are positioned to the bottom case; and projection portions that contact the disc tray with the rail guides when the disc tray is positioned inside the optical disc unit.

In the optical disc unit of the present invention, the disc tray includes two of the projection portions, and the rail guides include four of the projection portions. when the disc tray is positioned inside the optical disc unit, the two projection portions of the disc tray contact with two of the four projection portions of the rail guides to support a near side of the disc tray, the near side being in the depth direction, and the other two projection portions of the rail guides support a deep side of a bottom surface of the disc tray, the deep side being in the depth direction.

According to the present invention, the optical disc unit in which a tilt of the disc tray is reduced relative to the body can be provided to contribute to the improvement in reliability of the optical disc unit.

### BRIEF DESCRIPTION OF THE DRAWINGS

These and other features, objects and advantages of the present invention will become more apparent from the following description when taken in conjunction with the accompanying drawings wherein:

FIG. 1 is a first perspective view of an optical disc unit viewed from diagonally upper front in one embodiment;

FIG. 2 is a perspective view of the optical disc unit viewed from diagonally lower front in one embodiment;

FIG. 3 is a second perspective view of the optical disc unit viewed from diagonally upper front in one embodiment;

FIG. 4 is a third perspective view of the optical disc unit viewed from diagonally upper front in one embodiment;

FIG. 5 is a first sectional view of the optical disc unit in one embodiment;

FIG. 6 is a second sectional view of the optical disc unit in one embodiment;

FIG. 7 is a third sectional view of the optical disc unit in one embodiment;

FIG. 8 is a fourth sectional view of the optical disc unit in one embodiment;

FIG. 9 is a first sectional view of an optical disc unit in a past example;

FIG. 10 is a second sectional view of the optical disc unit in the past example;

FIG. 11 is a first enlarged view of a rail guide in one embodiment;

FIG. 12 is a second enlarged view of the rail guide in one embodiment;

FIG. 13 is a third enlarged view of a rail guide in one embodiment;

FIG. 14 is a fourth enlarged view of the rail guide in one embodiment; and

FIG. 15 is a fifth sectional view of the optical disc unit in one embodiment.

### DETAILED DESCRIPTION OF THE EMBODIMENT

Embodiments of the present invention are explained below in reference to the drawings.

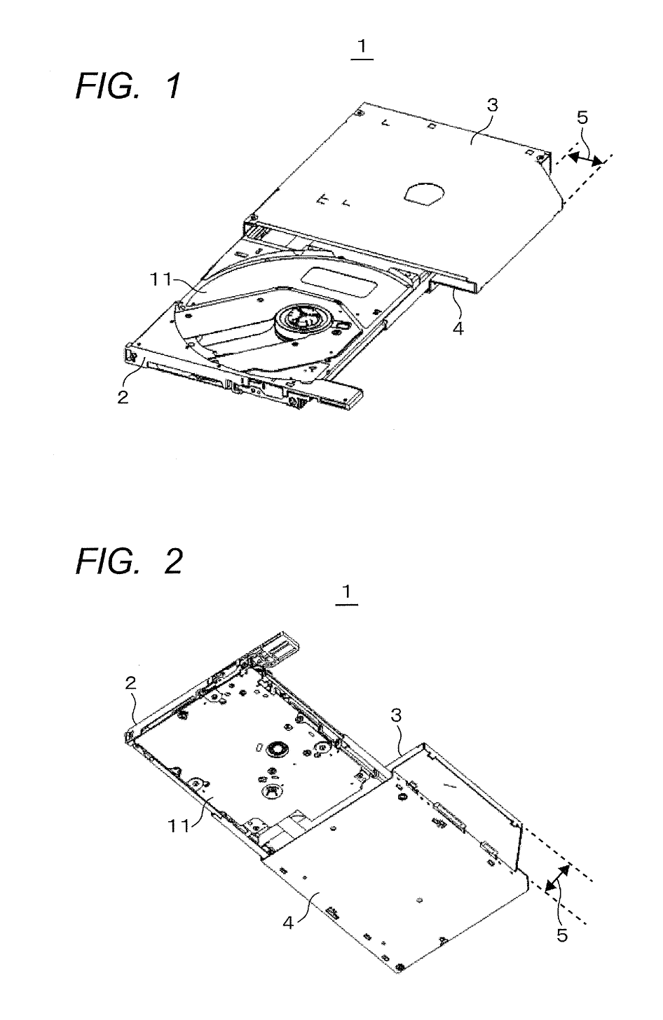

FIG. 1 is a first perspective view of an optical disc unit 1 viewed from diagonally upper front. A disc tray 11 that has been drawn out of the optical disc unit 1 is shown from rightward front. A front panel (also called a bezel) 2 is attached to the near side of the disc tray 11 in FIG. 1. A top case 3 and a bottom case 4 externally cover the optical disc unit 1 from top and bottom in the state in which the disc tray 11 has been stored inside the optical disc unit 1. The top case 3 and bottom case 4 are formed of metal including aluminum in many cases. Since the bottom case 4 in particular is a reference of a mount position of each component of the optical disc unit 1, it is also called a bottom chassis.

The disc tray 11 holds part of an optical disc to be carried. On the other hand, the top case 3 and bottom case 4 have sizes sufficient to cover the overall optical disc when the optical disc carried by the disc tray 11 has inserted in the optical disc unit 1. In FIG. 1, for example, the top case 3 and bottom case 4 expand in width from the disc tray 11 rightward on the figure by a portion shown by the reference numeral 5. The portion of the reference numeral 5 is also called a wing portion. FIG. 1 shows the top case 3 and much of the wing portion 5.

FIG. 2 is a perspective view of the optical disc unit 1 viewed from diagonally lower front in one embodiment. FIG. 2 shows the bottom case 4 and much of the wing portion 5. The optical disc unit 1 shown in FIG. 1 and FIG. 2 is one example, and does not limit this embodiment. For example, a different shape of the disc tray 11, a different shape and position of the wing portion 5, etc., can be considered, to each of which this embodiment is applicable.

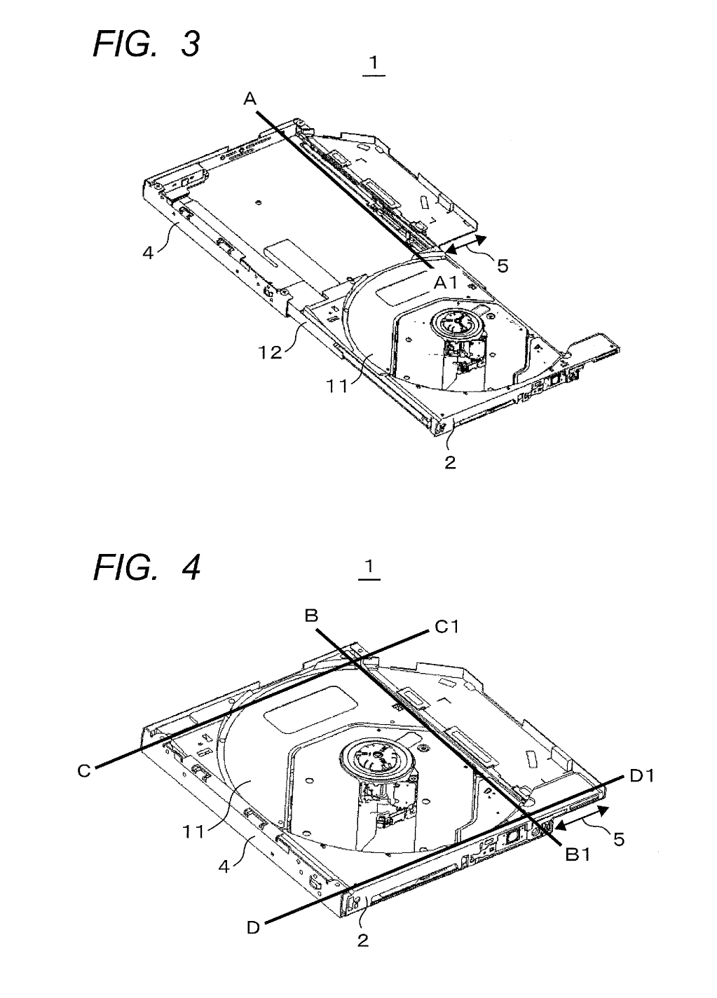

FIG. 3 is a second perspective view of the optical disc unit 1 viewed from diagonally upper front, in which the disc tray 11 that has been drawn out of the optical disc unit 1 is viewed from leftward front, unlike FIG. 1. Further, unlike in FIG. 1, the top cover 3 has been removed. One of rails 12 later explained is shown on the near side of the figure.

FIG. 4 is a third perspective view of the optical disc unit 1 viewed diagonally upper front, and shows the disc tray 11 that has been stored inside the optical disc unit 1, unlike FIG. 3. In this case, since the rails 12 are located inside the optical disc unit 1 in response to the position of the disc tray 11, it is not shown.

Next, in reference to a cross section taken along line A-A1 in FIG. 3 and a cross section B-B1 in FIG. 4, the positional relationship between the disc tray 11 and other components in this embodiment is explained.

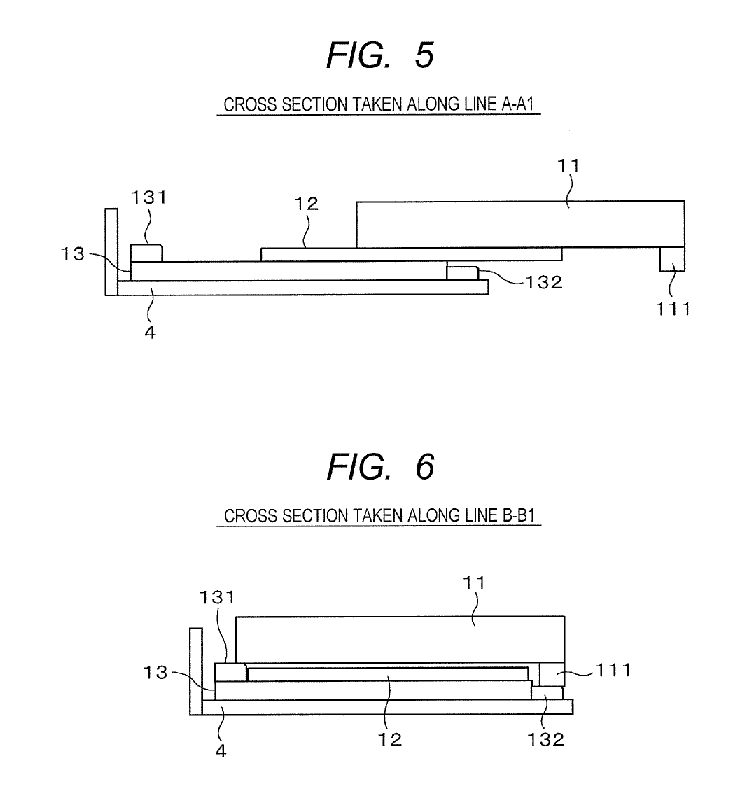

FIG. 5 is a first sectional view of the optical disc unit 1 in one embodiment to show the cross section taken along line A-A1 of FIG. 3. For easy understanding, a schematic diagram is used instead of a pictorial representation.

FIG. 6 is a second sectional view of the optical disc unit 1 in one embodiment, and shows the cross section taken along line B-B1 of FIG. 4 in the same manner as FIG. 5.

FIG. 5 and FIG. 6 show the bottom case 4, the disc tray 11, the rails 12, rail guides 13, a projection portion 111 of the disc tray, and projection portions 131 and 132 of the rail guide. By comparing both figures, the positional relationship between the components in the optical disc unit 1 out of which the disc tray 11 has been drawn and in the optical disc unit 1 in which the disc tray 11 has been stored is made apparent.

When the disc tray 11 moves, the rails 12 guided in the front-to-back direction by the rail guides 13 attached to the bottom case 4 slide, and then the disc tray 11 slides relative to the rails 12. For this reason, as shown in FIG. 3 above, when the disc tray 11 has been drawn out of the optical disc unit 1, part of the rails 12 appear outside the optical disc unit 1. In this state, the rails 12 support the disc tray 11.

There is also a technique of directly supporting the disc tray 11 by use of the rail guides 13 attached to the bottom case 4 without use of the rails 12. However, since the support strength in this technique is weaker than that of this embodiment, the rails 12 may intervene between the disc tray 11 and rail guides 13.

In many cases, the disc tray 11 is formed of a resin material such as polycarbonate, the rails 12 are formed of a metallic material such as stainless steel or aluminum, and the rail guides 13 are formed of a resin material such as polyacetal.

The disc tray 11 and rails 12 are in surface-to-surface contact with each other. The rails 12 and rail guides 13 are in surface-to-surface contact with each other. Even with a high machining accuracy, a clearance (rattle) of about 0.1 mm generates in the surface-to-surface contacts. Actually, it is well known that, when the disc tray 11 has been drawn out of the optical disc unit 1 as shown in FIG. 5, the disc tray 11 rattles in some degree in the up-and-down direction, depth direction, and both twist directions in the figure.

When the disc tray 11 is in the position shown in FIG. 5, this clearance does not cause a big disadvantage. However, when the disc tray 11 is inside the optical disc unit 1, this clearance causes a disadvantage. For example, when the disc tray 11 that has carried an optical disc moves from the position of FIG. 5 into the optical disc unit 1, the front panel 2 of FIGS. 3 and 4 contacts with a body of a PC incorporating the optical disc unit 1, and thus the optical disc may not be inserted into the optical disc unit 1. Contrarily, in occurrence of the same event as above when the disc tray 11 that has carried an optical disc moves out of the optical disc unit 1, the optical disc may not be ejected from the optical disc unit 1.

In this embodiment, FIG. 6 shows a technique of reducing malfunctions of the insertion and ejection due to the above clearance. That is, one of the rail guides 13 has the projection portions 131 and 132. When the disc tray 11 has been stored inside the optical disc unit 1 or part of the disc tray 11 is slightly outside the optical disc unit 1, the disc tray 11 is supported not by the rails 12 but by the rail guides 13 via the projection portions. Additionally, in FIG. 6, unlike the state of FIG. 5, the disc tray 11 is supported not via the movable component but by the opposition of the small areas with some stress. That is, the deep side of the bottom surface of the disc tray 11 (left side of FIG. 6) contacts with the projection portion 131 of the bottom case 4 with stress, and the near side of the bottom surface of the disc tray 11 (right side of FIG. 6) contacts with the projection portion 132 of the bottom case 4 with stress, so that the above clearance is reduced. Accordingly, the above tilt of the disc tray 11 is reduced, and malfunctions of the insertion or ejection of optical discs are also reduced.

In the example of FIG. 6, as one characteristic, gaps in the height direction are provided between the disc tray 11 and rails 12 by the projection portions 111, 131, and 132.

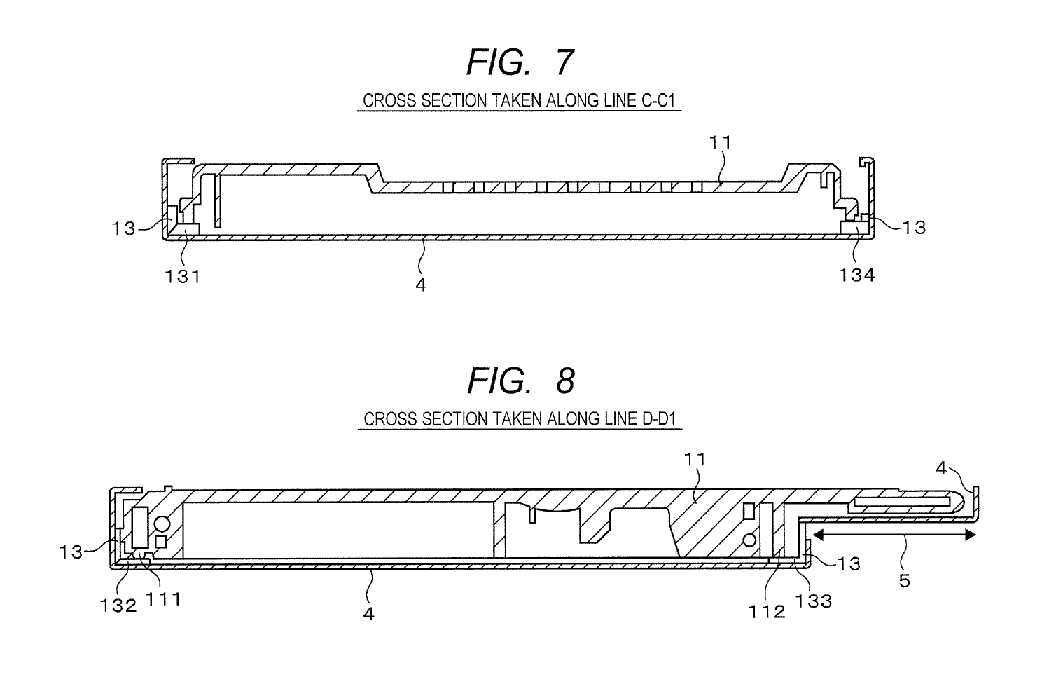

FIG. 7 is a third sectional view of the optical disc unit 1 in one embodiment to show a cross section taken along line C-C1 of FIG. 4.

FIG. 8 is a fourth sectional view of the optical disc unit 1 in one embodiment to show a cross section taken along line D-D1 of FIG. 4. Unlike FIG. 5 and FIG. 6, FIG. 7 and FIG. 8 show pictorial representations instead of schematic diagrams.

As apparent from FIGS. 6 to 8, the projection portion 111 and a projection portion 112 of the disc tray 11 contact with the projection portions 132 and 133 of the rail guides 13 with stress, and the deep side of the bottom surface of the disc tray 11 contacts with the projection portion 131 and a projection portion 134 of the rail guides 13 with stress.

The number of the contact positions may be not four but three. In that case, two contact positions may be provided on the near side (cross section taken along line D-D1), and one contact position may be provided on the deep side (cross section taken along line C-C1). In the state of FIG. 6, since the influence of the clearance generated on the deep side far from the front panel 2 is less than that of the clearance generated on the near side, the desired advantageous effect works even in such an embodiment.

A past example is shown here and characteristics of this embodiment are made further apparent.

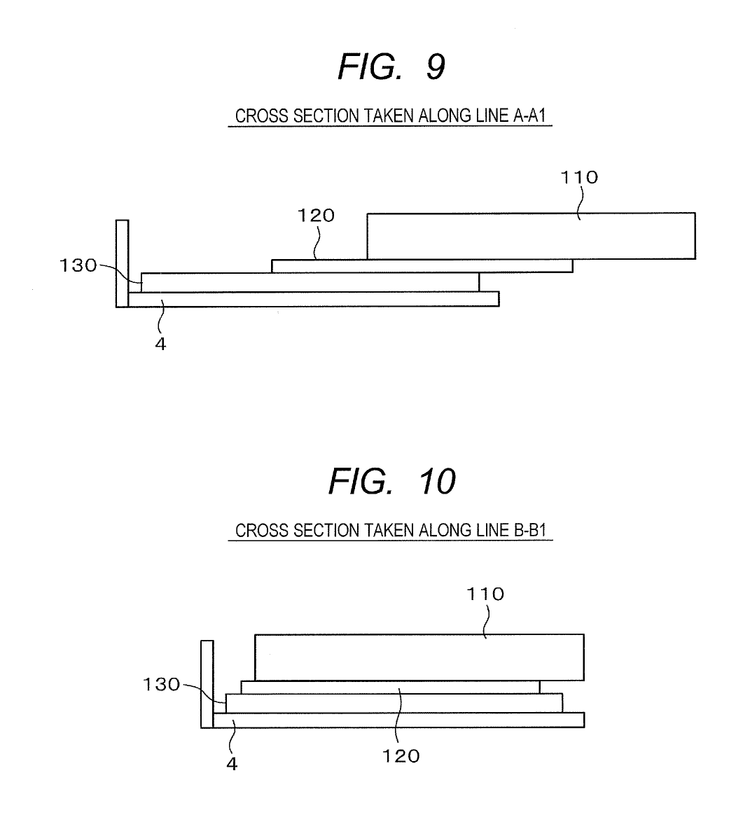

FIG. 9 is a first sectional view of an optical disc unit in the past example to show the state corresponding to FIG. 5 in this embodiment.

FIG. 10 is a second sectional view of the optical disc unit in the past example to show the state corresponding to FIG. 6 in this embodiment. As apparent from FIG. 10, in the past optical disc unit, unlike the above embodiment, a disc tray 110 is supported by rail guides 130 via rails 120 even when the disc tray 110 has been stored inside the optical disc unit 1. Therefore, also in this state, the disc tray 110 rattles in the up and down direction, left and right direction, and twist direction to some degree. The front panel 2 is likely to contact with the body of the PC incorporating the optical disc unit 1. For this reason, it is apparent that the above malfunctions of insertion and ejection of an optical disc occur more often than in this embodiment.

In this embodiment, the stress to the rail guides 13 via each projection portion may be required to support the disc tray 11 in FIG. 6. An example of the configuration of the rail guides 13 for generating this stress is explained below.

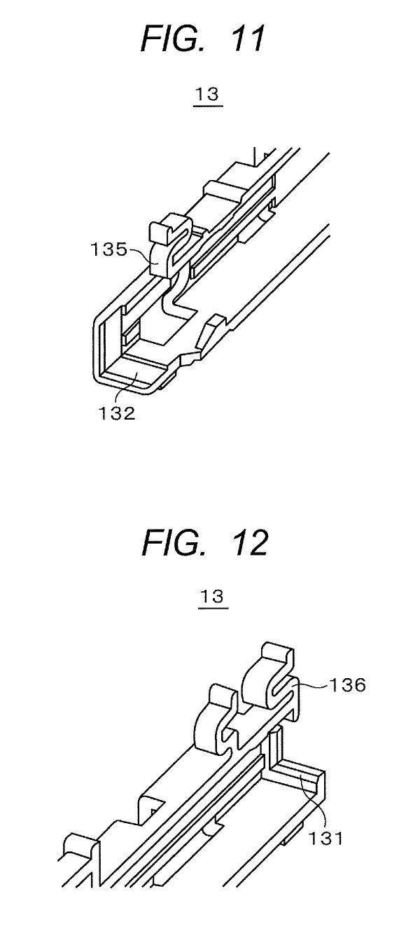

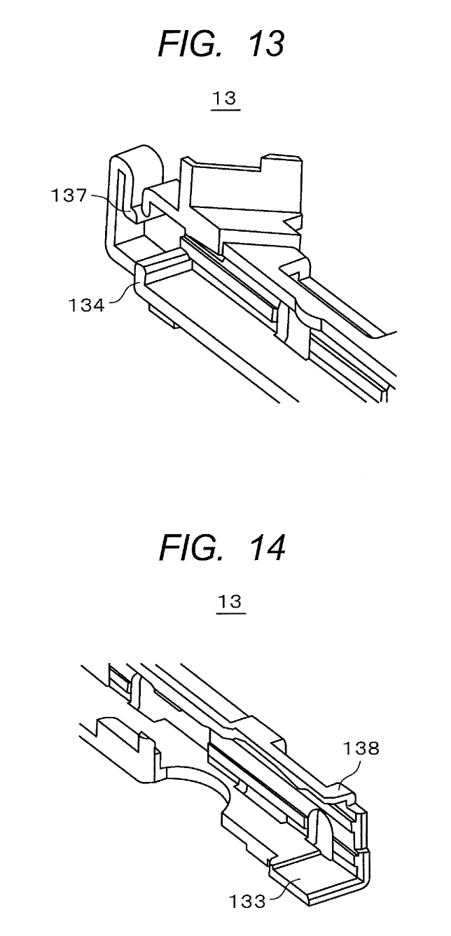

FIGS. 11 to 14 are first to fourth enlarged views of the rail guides 13 in one embodiment. The optical disc unit 1 has two rail guides 13 to support the left and right sides of the disc tray 11. FIG. 11 shows the near side of the left rail guide. FIG. 12 shows the deep side of the left rail guide. FIG. 13 shows the deep side of the right rail guide. FIG. 14 shows the near side of the right rail guide.

For example, leaf-spring-like support portions 135 to 138 are provided to the rail guides 13 to apply stress to the disc tray 11 from its lower surface on the figure to reduce the above clearance.

FIGS. 11 to 14 also show the projection portions 131 to 134. That is, the projection portions 131 and 132 support the disc tray 11 from its lower side and left side viewed on the illustration of FIG. 3. The projection portions 133 and 134 support the disc tray 11 from its lower side viewed on the illustration of FIG. 3. As a result, the clearance in the left-and-right direction is also reduced with respect to the disc tray 11.

Next, a modification of this embodiment is explained.

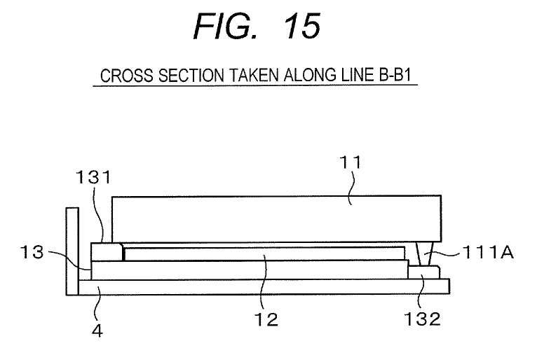

FIG. 15 is a fifth sectional view of the optical disc unit in one embodiment. Each component corresponds to that in FIG. 6 in the above embodiment. For example, the cross section of a projection portion 111A decreases toward the contact portion with the projection portion 132 to be further close to a point contact. The shape of the projection portion 111A may be the same as in FIG. 6. The cross section area of the projection portion 132 may decrease toward the contact portion. The technique shown in FIG. 15 is applied also to the projection portion 111 of FIG. 8.

When the contact area is reduced as long as a strength of the contact portion of each projection portion is sufficient, generation of a clearance (rattle) due to a warp of the contact surface is advantageously further reduced.

The same technique is applicable also to the support portions 135 to 138 of FIGS. 11 to 14. That is, when the support portions 135 to 138 have wide contact areas with the disc tray 11, a new clearance is like to generate in response to machining accuracy of the flat surfaces. Therefore, the contact areas of the support portions 135 to 138 are reduced and their contacts are made by a similar technique to the point contact as long as the strengths of the contact portions are sufficient, so that a clearance may be reduced.

The above embodiments are examples and do not limit the present invention.

Although an embodiment which is different while it is based on the meaning of the present invention can be considered, there are all under the category of the present invention. While we have shown and described several embodiments in accordance with our invention, it should be understood that disclosed embodiments are susceptible of changes and modifications without departing from the scope but intend to cover all such changes and modifications that fall within the ambit of the appended claims.

What is claimed is:

1. An optical disc unit that inserts an optical disc therein as a recording medium and ejects the inserted optical disc externally,
the optical disc unit comprising:
a bottom case that packages a bottom side of the optical disc unit;
a disc tray that carries the optical disc and inserts the optical disc inside the optical disc unit, and ejects the optical disc to an outside;
rails that guide and move the disc tray while changing a relative position thereof;
rail guides that guide and move the rails while changing relative positions thereof and that are positioned to the bottom case; and
projection portions that contact the disc tray with the rail guides when the disc tray is positioned inside the optical disc unit.

2. The optical disc unit according to claim 1,
wherein the disc tray includes two of the projection portions, the rail guides include four of the projection portions,
when the disc tray is positioned inside the optical disc unit, the two projection portions of the disc tray contact with two of the four projection portions of the rail guides to support a near side of the disc tray, the near side being in a depth direction, and the other two projection portions of the rail guides support a deep side of a bottom surface of the disc tray, the deep side being in in the depth direction.

3. An optical disc unit according to 1,
wherein the disc tray includes two of the projection portions, the rail guides include three of the projection portions,
when the disc tray is positioned inside the optical disc unit, the two projection portions of the disc tray contact with two of the three projection portions of the rail guides to support a near side of the disc tray, the near side being in the depth direction, and the rest one projection portion of one of the rail guides supports a deep side of a bottom surface of the disc tray, the deep side being in the depth direction.

4. The optical disc unit according to claim 1,
wherein, when the disc tray is positioned inside the optical disc unit, the rail guides have support portions to apply, to the disc tray, stress to the rail guide.

5. The optical disc unit according to claim 1,
wherein the disc tray and the rail guides have the projection portions, the projection portions contact with each other when the disc tray is positioned inside the optical disc unit, and
each horizontal cross section of all or part of the projection portions decreases toward the contact portion.
